(19) United States
(12) Patent Application Publication
(10) Pub. No.: US 2007/0062772 A1
(43) Pub. Date: Mar. 22, 2007

(54) Method for operating a drive train of a motor vehicle

(75) Inventors: Michael Kollender, Boeblingen (DE); Anton Rink, Calw (DE); Joachim Schaefer, Welzheim (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler, Stuttgart (DE)

(21) Appl. No.: 10/553,966

(22) PCT Filed: Mar. 9, 2004
(86) PCT No.: PCT/EP04/02386

§ 371 Date: Oct. 24, 2006

(30) Foreign Application Priority Data
Apr. 19, 2003 (DE) 10318033.8

(51) Int. Cl. B60W 10/02

(52) U.S. Cl. 192/3.55

(57) ABSTRACT

In a method for operating a motor vehicle drive train during a shifting operation of a gearwheel change gearbox, the clutch is triggered for closing before the target gear is fully engaged. A control device determines a triggering moment for the clutch as a function of operational parameters and/or state variables of the drive train. The control device calculates a required interval which is necessary until complete engagement of the target gear and an interval which is necessary until a gripping point of the clutch is reached. An optimum triggering moment is determined from these intervals. The tractive force interruption during a shifting operation is thus very short. At the same time, the completion of the shifting operation is ensured.

### BACKGROUND AND SUMMARY OF THE INVENTION

The present invention relates to a method for operating a drive train of a motor vehicle with an automated gearwheel change gearbox, an automated clutch, and a control device for controlling the gearwheel change gearbox and the clutch, the clutch being opened when shifting takes place from an original gear to a target gear of the gearwheel change gearbox.

A method for operating a drive train of a motor vehicle is described in EP 0 695 665 A1. The motor vehicle has an automated gearwheel change gearbox in the form of a servo-assisted gearbox, a control device in the form of a gearbox control unit and an automated clutch in the form of a clutch which can be engaged and disengaged by the gearbox control unit. When shifting takes place from an original gear to a target gear of the gearwheel change gearbox, the clutch is opened or disengaged by the control device. Shifting consists of various phases, one phase only beginning when the previous phase is completely finished. For example, the clutch is only closed when the engagement of the target gear has been completed. Shifting is completed when the target gear is engaged and the clutch has been closed or engaged again.

An object of the present invention is to provide a method for operating a drive train of a motor vehicle which makes rapid shifting operations possible and, at the same time, ensures complete performance of the shifting operations; According to the invention, that object has been achieved by a method triggering the automated clutch for closing before the target gear is fully engaged, and determining a trigger moment (t_{trig}) for the automated clutch as a function of at least one of operational parameters and state variables of the drive train.

According to the invention, the control device triggers the clutch for closing before the target gear is fully engaged. In an automated gearwheel change gearbox, the target gear is engaged by a shifting actuator which is triggered by the control device. It is fully engaged when a shifting element of the target gear, for example a sliding sleeve, actuated during shifting and thus the shifting actuator itself as well have reached a target position. The engagement of the target gear and the triggering and consequently the closing of the clutch thus take place at least partly in parallel.

The automated clutch, which is arranged in particular between a driving engine and the gearwheel change gearbox, can be opened and closed by a clutch actuator which is triggered by the control device. With the clutch open, the driving engine and the gearbox are separated and, with the clutch closed, they are connected. In this respect, the control device can set any desired clutch position between completely open and completely closed. The clutch and the gearwheel change gearbox can also be triggered by two separate control devices.

The control device determines a triggering moment for the clutch as a function of operational parameters and/or state variables of the drive train. The triggering moment is the moment at which the control device begins to control the clutch actuator in such a way that the clutch is closed.

Operational parameters are for example:
rotational speeds and rotational speed gradients of the clutch and of the gearwheel change gearbox,
torques of the driving engine, at the clutch and at the gearwheel change gearbox,
the clutch position,
a speed of the motor vehicle,
triggering signals for the actuators of the clutch and of the gearwheel change gearbox, and
a temperature of the clutch and of the gearwheel change gearbox.

State variables are for example:
a reaction time of the clutch, that is a time between triggering and actual position change of the clutch,
a time which is required for engaging the target gear,
a synchronous rotational speed of the target gear, that is the rotational speed of a gearbox input shaft which appears at a current speed of the motor vehicle with the target gear engaged,
a shifting type, that is upshifting or downshifting, and
a shifting mode which indicates whether a shifting operation is carried out in “sport” style or comfortably.

The reaction time of the clutch must be taken into consideration in particular in the case of hydraulic actuation of the clutch, that is when use is made of a hydraulic clutch actuator. The reaction time or dead time of the hydraulic triggering may be between 30 and 50 ms.

In order to ensure that the target gear is engaged safely, the shifting elements of the gearwheel change gearbox which are involved in engagement, for example a sliding sleeve and a gearwheel, must not be acted on with torque. This is achieved by opening the clutch during shifting. Engagement must be completed before the clutch position reaches a gripping point. At the gripping point, clutch disks come into contact with one another, and the clutch can thus transmit torque as from this position. After the gripping point has been reached, therefore, torque can thus be transmitted from the driving engine via the clutch to the gearwheel change gearbox and thus make engagement of the target gear impossible. This measure is taken into consideration by the control device in the determination of the triggering moment for the clutch.

The time required for shifting, i.e., the shifting time, is thus short as the engagement of the target gear and the triggering and the closing of the clutch take place at least partly in parallel. The tractive power interruption, that is the time for which the driving engine can deliver no torque via the gearwheel change gearbox to driven vehicle wheels, is consequently very short. A vehicle driver can thus accelerate the motor vehicle again shortly after initiating a shifting operation. At, the same time, the engagement of the target gear, that is the completion of the shifting operation, is ensured by the present invention. Safety-critical driving situations in which, for example, the vehicle driver has to accelerate the motor vehicle but cannot because of a gear not being engaged are thus prevented.

In a further development of the invention, the control device determines the triggering moment as a function of a desired profile of a clutch position during closing of the clutch. From the desired profile, the control device determines the triggering, that is a profile of a triggering signal, for the clutch, or the clutch actuator. The desired profile of the clutch position can thus also be taken into consideration indirectly in the form of a desired profile of the triggering signal. The interval between the triggering moment and the gripping point being reached is substantially dependent on the desired profile of the clutch position. By taking the desired profile into consideration, the interval can be determined very accurately, and the triggering moment can thus also be determined accurately with regard to the shifting time and safe completion of the shifting operation.

In a still further development of the invention, the desired profile of the clutch position has a smaller gradient within a range around the gripping point of the clutch than outside the range. The range does not have to be symmetrical in relation to the gripping point. Moreover, the gradient of the desired profile can be different before and after the gripping point, and the gradient can also change. The gradient can in particular be constant in sections. For example, the profile can have a first gradient from a starting position until it reaches the range around the gripping point, a second gradient within the range, then a third gradient, and a fourth gradient in a range before reaching the closed position. In this connection, the first gradient is greater than the second, the third is likewise greater than the second, and the fourth is smaller than the third gradient. The smaller fourth gradient serves, for example, to allow a subsequently activated clutch regulator to be fully initialized.

The clutch position thus approaches the gripping point rapidly to a settable spacing, reaches the gripping point at a slow speed and then changes again rapidly in the direction of the closed position. To this end, the position of the gripping point is stored in the control device. In addition, the gripping point can be adapted by methods known per se.

In the event of too great a gradient of the desired profile, that is too rapid a change in the clutch position when it reaches the gripping point, the clutch disks meet one another at great speed, which can lead to a noticeable jerk or a noise. If the clutch were closed at only one speed at which no jerk can occur when the gripping point is reached, closing of the clutch and thus shifting as well would take a very long time.

With the desired profile of the clutch position as described, rapid closing of the clutch and thus a short shifting time and at the same time comfortable shifting is made possible. Moreover, the closing of the clutch can be varied, for example adapted to a driving style of the vehicle driver, by changing the gradients outside the range without the behavior changing when the gripping point is reached.

In another development of the invention, the control device determines a first interval which is necessary in order to engage the target gear. This is carried out in particular during synchronization of the gearbox input shaft to the synchronous rotational speed in the target gear as, starting from a rotational speed gradient of the gearbox input shaft, the end of synchronization and from there the moment at which the target gear is engaged can be precalculated. The time for the shifting-through of the target gear, that is the engagement of the target gear after synchronization has taken place, can be determined as a function of, for example, the target gear, the desired profile of the triggering signal and/or a temperature of the gearwheel change gearbox from a stored characteristic set or by means of a model calculation. If the clutch can be closed very rapidly, that is if the interval between the triggering moment and the reaching of the gripping point is shorter or only slightly longer than the time required for the shifting-through of the target gear, the end of synchronization can be detected and calculation started from this moment.

In addition, the control device determines a second interval which is necessary in order to reach the gripping point of the clutch. As already described, this interval is determined from a current position of the clutch and a desired profile of the clutch position.

The control device determines the triggering moment from the intervals. The determination starts from the moment, precalculated by the first interval, at which the target gear will be engaged. Taking the second interval into consideration, it is thus possible to determine when the triggering moment may at the earliest occur, in order that the gripping point is not reached before the engagement of the target gear. A suitable triggering moment can thus be fixed very accurately.

In yet another development of the invention, the control device takes a safety period into consideration in the determination of the triggering moment. The triggering moment is moved back by the safety period, for example, i.e., to a later moment. This takes account of an inevitable uncertainty of the precalculation of the intervals. The cause of the uncertainties lies in, for example, wear of the components involved in shifting, component variation, for example of the actuators, and/or a reaction time during setting of the desired clutch position.

Consideration of the safety period guarantees that shifting can also be completed safely.

According to the invention, the safety period is variable. the influences on the uncertainties in the precalculation of the two intervals can change during operation of the motor vehicle. By way of a corresponding variation, i.e., an adaptation of the safety period, the triggering moment can be adapted optimally to the current circumstances. This makes short shifting times possible and at the same time guarantees that shifting can be completed safely.

In one aspect of the invention, the control device compares the clutch position with progress of the engagement of the target gear during closing of the clutch. A measure of the progress is a measured position of the shifting actuator, for example. The target gear should be engaged when the clutch reaches a given position, for example. Depending on a result of the comparison, the control device changes the desired profile of the clutch position. In this connection, the control device can break off the closing of the clutch, hold the clutch position constant or reduce the gradient of the desired profile, for example.

The control device thus checks during closing of the clutch whether the engagement of the target gear is still possible at all before closing of the clutch or whether, owing to a malfunction of the shifting actuator for example, the target gear can no longer be engaged in time. It is thus recognized early, if necessary, that the shifting operation could not be completed without intervention in the triggering of the clutch. In this case, the clutch is opened again, and engagement of the target gear is consequently made possible.

The completion of the shifting operation is thus guaranteed even in the event of incorrect determination of the triggering moment or the occurrence of unforeseeable events.

In another aspect of the invention, the safety period is varied as a function of a third interval between a moment at which the target gear is fully engaged and a moment at which the clutch reaches the gripping point. If, for example, the third interval is shorter than a desired value, the safety period can be extended, and the third period can thus be extended. Shortening is likewise possible. The third period can thus be set to a desired value or in a range around a desired value.

The safety period can moreover be varied as a function of the result of said comparison of the clutch position with the progress of the engagement of the target gear. If the clutch had to be opened again, for example, this is an indication that the calculation of the first and second periods was not correct or that there is a malfunction. In this case, for example, the safety period can be extended.

In addition, the safety period can be varied as a function of a failure of the engagement of the target gear as a result of the gripping point being reached too early. In the event of a failure, for example, the safety period can be extended. The safety period can thus be adapted optimally to a requirement and to the actual circumstances.

In a yet further development of the invention, the control device changes the desired profile of the clutch position as a function of the comparison of the clutch position with the progress of the engagement of the target gear. If the clutch had to be opened again, the desired profile can be changed in such a way, for example, that the clutch is closed more slowly. The comfort of the shifting operation can thus be increased while the shifting time remains the same.

### BRIEF DESCRIPTION OF THE DRAWINGS

FIG. 1 is a schematic view showing part of a drive train of a motor vehicle with an automated clutch and an automated gearwheel change gearbox, and

FIG. 2 is a flow diagram of a method of the present invention for operating the drive train during a shifting operation.

### DETAILED DESCRIPTION OF THE DRAWINGS

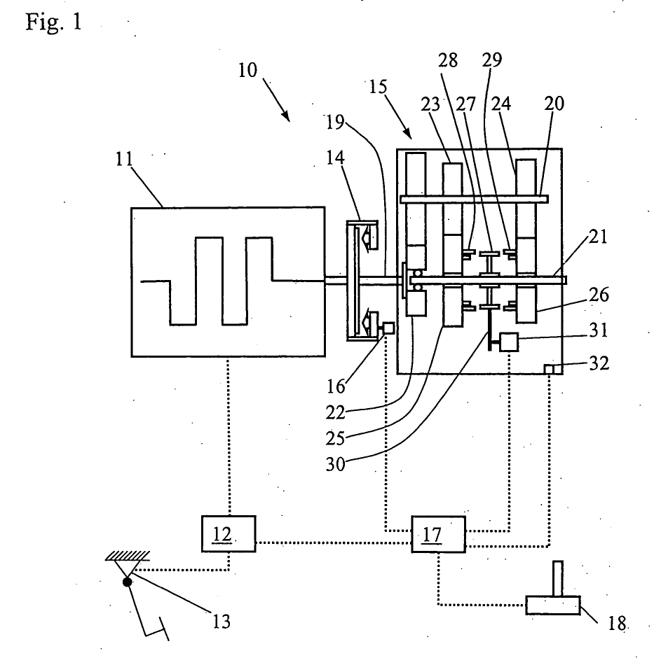

According to FIG. 1, a drive train 10 of a motor vehicle (not illustrated) has a driving engine 11 which is controlled by a control device 12. The control device 12 is in signal communication with a power control element 13 so that a vehicle driver can specify requirements for the setting of a throttle valve or a delivered torque of the driving engine 11.

The driving engine 11 is connected to an automated gearwheel change gearbox 15 by an automated clutch 14. A power flow between the driving engine 11 and the gearwheel change gearbox 15 can be brought about and separated by the clutch 14. The clutch 14 is actuated by a clutch actuator 16 in the form of a hydraulic piston/cylinder unit. The hydraulic lines, valves and hydraulic pump necessary are not illustrated. The clutch actuator 16 is triggered by the control device 17. Moreover, the clutch actuator 31 detects its current position and thus the clutch position and sends this to the control device 17. The control device 17 is moreover in signal communication with a shift lever 18, so that the vehicle driver can initiate shifting operations in the gearwheel change gearbox 15. Alternatively, shifting operations can also be initiated by the control device 17 as a function of shifting characteristic sets known per se.

The gearwheel change gearbox 15 has a gearbox input shaft 19, which is connected to the clutch 14, a countershaft 20 and a gearbox output shaft 21, which is connected via an axle gearing (not illustrated) to driven wheels (not illustrated) of the motor vehicle. The gearbox input shaft 19 is connected to the countershaft 20 by a constant 22. Two fixed wheels 23, 24 for 1^{st} and 2^{nd} gear of the gearwheel change gearbox 15 are arranged in a rotationally fixed manner on the countershaft 20. The fixed wheels 23, 24 mesh with associated loose wheels 25, 26, which are arranged rotatably on the gearbox output shaft 21. In each case one of the two loose wheels 25, 26 can be connected in a rotationally locked manner to the gearbox output shaft 21 by a shifting element 27 configured as a sliding sleeve and arranged in a rotationally locked and axially movable manner on the gearbox output shaft 21. Synchronizing devices 28, 29, which can be actuated by the shifting element 27, are moreover arranged on the loose wheels 25, 26. Rotational speed adaptation during a shifting operation is achieved by the synchronizing devices 28, 29.

In 1^{st} gear, the loose wheel 25 is connected to the gearbox output shaft 21 by the shifting element 27. When shifting takes place from 1^{st} to 2^{nd} gear, the first step is for the delivered torque of the driving engine 11 to be reduced and the clutch 14 to be opened. Then the shifting element 27 is brought into the illustrated neutral position. Subsequently by further axial displacement, first the rotational speed of the countershaft 20 and of the gearbox input shaft 19 is brought to the rotational speed of the 2^{nd} gear, the synchronous rotational speed, and then the loose wheel 26 is connected in a rotationally locked manner to the gearbox output shaft 21 and thus the 2^{nd} gear is engaged. The 2^{nd} gear is thus engaged in the gearwheel change gearbox 15. At least partly in parallel with the engagement of the 2^{nd} gear, the clutch 14 is closed and then the delivered torque of the driving engine 11 is increased again.

The shifting element 27 is connected via a connecting element 30 to a shifting actuator 31 in the form of a hydraulic piston/cylinder unit. The hydraulic lines, valves and hydraulic pump necessary are not illustrated. The shifting actuator 31 is triggered by the control device 17 by means of a triggering signal. Moreover, the shifting actuator 31 detects its current position and thus the position of the shifting element 27 and sends this to the control device 17. The shifting element 27 can thus be displaced axially along the gearbox output shaft 21 as per the control device 17, and the gears of the gearwheel change gearbox 15 can be engaged and disengaged.

In addition, the control device 17 is in signal communication with a temperature sensor 32 arranged inside the gearwheel change gearbox 15. A temperature of the gearwheel change gearbox 15 can be measured with the aid of the temperature sensor 32.

The gearwheel change gearbox can comprise further gears which can be engaged and disengaged via further shifting elements. In this case, during a shifting operation, the shifting element of the target gear is first selected by a selecting actuator after disengagement of the original gear and then the target gear is engaged.

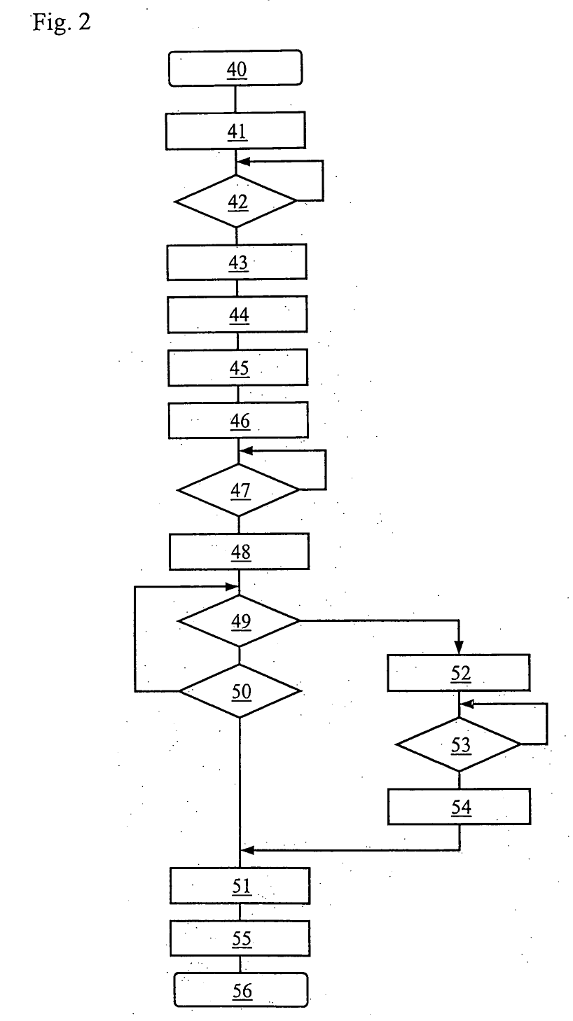

According to FIG. 2, a method for operating the drive train begins, during a shifting operation, with a shift request in block 40. The shift request can be initiated by the vehicle driver with the shift lever 16 or directly by the control device 17. The method is carried out by the control device 17 in a fixed time cycle, for example with a time cycle of 10 ms.

In the following block 41, the delivered torque of the driving engine 11 is reduced, and the clutch 14 is opened. Moreover, the original gear is disengaged by the shifting actuator 31, and the sliding sleeve 27 is moved in the direction of the loose wheel of the target gear. The control device 17 therefore controls the shifting actuator 31 in such a way that the target gear is engaged. The target gear is not yet engaged in block 41, however, but the engagement operation is only started and continued during the processing of the following blocks.

In the following inquiry block 42, it is checked whether synchronization has already begun and whether a settable period has expired since the beginning of synchronization. The beginning of synchronization is determined using the position of the shifting actuator 31 whose position at the beginning of synchronization is known. If the result of the check is positive, the method is continued in block 43. In the case of a negative result, inquiry block 42 is repeated. It should be mentioned here that, in all the inquiry blocks in FIG. 2, the method continues according to the output of the inquiry block downward in the event of a positive result of the check and according to the output to the side in the event of a negative result.

The rotational speed of the gearbox input shaft 19 changes during synchronization. In this connection, it takes a certain time until a virtually constant gradient of the rotational speed appears. For this reason, block 43 is only carried out a period after the beginning of synchronization. In block 43, the gradient grad_{gis} of the rotational speed n_{gis} of the gearbox input shaft 19 is determined from the rotational speeds n_{gis1} and n_{gis2} on two measurements of the rotational speed n_{gis} and the moments t₁ and t₂ of the measurements.

$${grad}_{gis} = \frac{{n}_{gis 2} - {n}_{gis 1}}{{t}_{2} - {t}_{1}}$$

The synchronization is completed when the rotational speed n_{gis} reaches the synchronous rotational speed n_{sync} of the target gear. The synchronous rotational speed n_{sync} follows from the rotational speed n_{gos} of the gearbox output shaft 21 and the ratio of the target gear i_{targ}. The rotational speed n_{gos} can be measured directly or calculated from rotational speeds of the driven vehicle wheels and an axle ratio.
n_{sync}=n_{gos}*i_{targ}

Also in block 43, starting from the moment t₂, the synchronizing time Δt_{sync} also necessary is calculated from the rotational speed n_{gis2}, the gradient grad_{gis} and the synchronous rotational speed n_{sync}:

$$Δ {t}_{sync} = \frac{{n}_{sync} - {n}_{gis 2}}{{grad}_{gis}}$$

In the following block 44, a shifting-though time Δt_{through}, which is necessary after the completion of synchronization in order to engage the target gear, is determined. The shifting-through time Δt_{through} is determined from a characteristic set stored in the control device 17 as a function of the target gear, a desired profile of the triggering signal of the shifting actuator 31 and a temperature measured in the gearwheel change gearbox 15. The characteristic set values are determined in a development phase using measurements and stored. The stored values can be adapted during operation of the motor vehicle by a comparison of the stored values with measured values.

An interval Δt_{eng}, which is necessary starting from the moment t₂ in order to engage the target gear, is determined from the necessary synchronizing time Δt_{sync} and the shifting-through time Δt_{through}.
Δt_{eng}=Δt_{sync}+Δt_{through}

An interval Δt_{grip}, which is necessary in order to bring the clutch 14 from a current clutch position to the gripping point, is determined in the following block 45. An interval Δt_{ideal}, which would be necessary if the clutch position were to follow the desired profile ideally, is determined from the desired profile of the clutch position. A reaction time Δt_{reac} is added to this interval Δt_{ideal}.
Δt_{grip}=Δt_{ideal}+Δt_{reac}

In block 46, starting from the moment t₂, the triggering moment t_{trig} at which the control device 17 begins to control the clutch actuator 16 in such a way that the clutch 14 is closed, is determined. The triggering moment t_{trig} is determined in such a way that the clutch position reaches the gripping point shortly after engagement of the target gear. In order for it to be possible to compensate for inevitable uncertainties in the precalculation of said times and intervals, a safety period Δt_{saf} is also taken into consideration in the determination of the triggering moment t_{trig}, by which t_{trig} is moved back. The triggering moment t_{trig} is calculated according to the following formula:
t_{trig}=t₂+Δt_{eng}+Δt_{saf}−Δt_{grip}

It is then checked in inquiry block 47 whether the triggering moment t_{trig} has been reached. If this is not the case, inquiry block 47 is repeated. When the triggering moment t_{trig} is reached, the control device 17 begins in block 48 to control the clutch actuator 16 according to a desired profile of the clutch position in such a way that the closing of the clutch 14 is begun. The clutch is not completely closed in block 48, but the closing operation continues during the processing of further blocks.

In the following inquiry block 49, the clutch position is compared with the position of the shifting actuator 31. In this connection, the clutch position and the shifting actuator position are indicated in [%] of the total travel necessary in the case concerned. That is, as far as the shifting actuator 31 is concerned, depending on the total travel until engagement of the target gear and, as far as the clutch position is concerned, depending on the travel until the gripping point is reached. The inquiry block 49 delivers a negative result if one of the following conditions is met:
the target gear is not yet engaged when the clutch position reaches a first checking position,
the integration of the difference in [%] between the clutch position and the shifting actuator position is greater than a first limit value,
the difference in [%] between the clutch position and the shifting actuator position is greater than a second limit value when the clutch position reaches a second checking position,
a gradient of the clutch position was or is for a period greater than a gradient of the shifting actuator position and at the same time the clutch position is greater than a third checking position and the shifting actuator position is smaller than a limit position and
a repeated precalculation of the clutch position and shifting actuator position starting from the current time and current values reveals that the clutch position reaches a maximum permitted position before the gear is engaged.

If one of said conditions is met, there is a risk of the gripping point being reached too rapidly and of it no longer being possible to engage the target gear.

In the case of a positive result, that is if none of the conditions is met, it is checked in inquiry block 50 whether the target gear has been engaged and the gripping point reached. In the case of a negative result, inquiry block 49 is repeated; in the case of a positive result, the method is continued in block 51.

In the case of a negative result in inquiry block 49, i.e., if one of the conditions is met, the clutch 14 is opened again in block 52, which safely makes possible engagement of the target gear. In the following inquiry block 53, it is checked whether the target gear is engaged. In the case of a negative result, inquiry block 53 is repeated.

In the case of a positive result in inquiry block 53, the clutch 14 is closed in block 54. The method is continued only when the gripping point is reached. Subsequently, the method is likewise continued in block 51.

An adaptation of the safety period Δt_{saf} is carried out in block 51. In this connection, it is checked whether the actual interval Δt_{act} between actual engagement of the target gear and the gripping point actually being reached lies within a tolerance range around a desired period Δt_{des}. If the actual interval Δt_{act} is longer than an upper limit of the tolerance range, Δt_{saf} is reduced by a value; if Δt_{act} is shorter than a lower limit of the tolerance range, Δt_{saf} is increased by a value. In this connection, the value can be predetermined or dependent on the actual interval.

If inquiry block 49 has delivered a negative result, that is the clutch 14 has been opened again in block 52, the desired period Δt_{des} and thus indirectly Δt_{saf} also is extended by a value. In this connection, the value can be predetermined or dependent on the clutch position and shifting actuator position at the moment of processing of inquiry block 49.

After the processing of block 51, the torque of the driving engine 11 is in block 55 set to the requirement of the vehicle driver again. The shifting operation and the method are thus completed in block 56.

The torque of the driving engine 11 can also be increased in parallel with the closing of the clutch 14.

1-11. (canceled)

12. A method for operating a drive train of a motor vehicle with an automated gearwheel change gearbox, an automated clutch, and a control device for controlling the gearwheel change gearbox and the clutch, the clutch being opened when shifting takes place from an original gear to a target gear of the gearwheel change gearbox, comprising triggering the automated clutch for closing before the target gear is fully engaged, and determining a triggering moment (t_{trig}) for the automated clutch as a function of at least one of operational parameters and state variables of the drive train.

13. The method as claimed in claim 12, wherein the triggering moment (t_{trig}) is determined as a function of a desired profile of a clutch position during closing of the clutch.

14. The method as claimed in claim 13, wherein the desired profile has a smaller gradient within a range around a clutch gripping point than outside said range.

15. The method as claimed in claim 12, wherein determining the triggering moment (t_{trig}) comprises determining a first interval t_{eng} which is necessary in order to engage the target gear and a second interval t_{grip} which is necessary in order to reach the gripping point of the clutch to determine the triggering moment (t_{trig}) from said intervals.

16. The method as claimed in claim 13, wherein determining the triggering moment (t_{trig}) comprises determining a first interval t_{eng} which is necessary in order to engage the target gear and a second interval (t_{grip}) which is necessary in order to reach the gripping point of the clutch to determine the triggering moment (t_{trig}) from said intervals.

17. The method as claimed in claim 15, wherein a safety period (t_{saf}) is taken into consideration in determining the triggering moment (t_{trig}).

18. The method as claimed in claim 16, wherein a safety period (t_{saf}) is taken into consideration in determining the triggering moment (t_{trig}).

19. The method as claimed in claim 17, wherein the safety period (t_{saf}) is variable.

20. The method as claimed in claim 17, wherein the safety period (t_{saf}) is variable.

21. The method as claimed in claim 12, further comprising comparing the clutch position with progress of the engagement of the target gear during closing of the clutch and, depending on a result of the comparing changing the desired profile of the clutch position.

22. The method as claimed in claim 21, further comprising in again opening the clutch after breaking off the closing of the clutch and again beginning to close the clutch only after the target gear is fully engaged.

23. The method as claimed in claim 19, wherein the safety period t_{saf} is varied as a function of at least one of a third interval t_{act} between a moment at which the target gear is fully engaged and a moment at which the clutch reaches the gripping point, the result of said comparison, and a failure of the engagement of the target gear.

24. The method as claimed in claim 20, wherein the safety period t_{saf} is varied as a function of at least one of a third interval t_{act} between a moment at which the target gear is fully engaged and a moment at which the clutch reaches the gripping point, the result of said comparison, and a failure of the engagement of the target gear.

25. The method as claimed in claim 21, wherein the desired profile of the clutch position is changed as a function of said comparison.

26. A control device for operating a drive train of a motor vehicle with an automated gearwheel change gearbox, an automated clutch, and a control device for controlling the gearwheel change gearbox and the clutch, the clutch being opened when shifting takes place from an original gear to a target gear of the gearwheel change gearbox, comprising:
means for triggering the clutch for closing before the target gear is fully engaged, and
means for determining a triggering moment (t_{trig}) for the automated clutch as a function of at least one of operational parameters and state variables of the drive train.

27. The control device as claimed in claim 26, wherein the triggering moment (t_{trig}) is determined as a function of a desired profile of a clutch position during closing of the clutch.

28. The control device as claimed in claim 27, wherein the desired profile has a smaller gradient within a range around a clutch gripping point than outside said range.

29. The control device as claimed in claim 26, wherein determining the triggering moment (t_{trig}) comprises determining a first interval t_{eng} which is necessary in order to engage the target gear and a second interval t_{grip} which is necessary in order to reach the gripping point of the clutch to determine the triggering moment (t_{trig}) from said intervals.

30. The control device as claimed in claim 27, wherein determining the triggering moment (t_{trig}) comprises determining a first interval t_{eng} which is necessary in order to engage the target gear and a second interval (t_{grip}) which is necessary in order to reach the gripping point of the clutch to determine the triggering moment (t_{trig}) from said intervals.

31. The control device as claimed in claim 29, wherein a safety period (t_{saf}) is taken into consideration in determining the triggering moment (t_{trig}).

32. The control device as claimed in claim 31, wherein a safety period (t_{saf}) is taken into consideration in determining the triggering moment (t_{trig}).

33. The control device as claimed in claim 31, wherein the safety period (t_{saf}) is variable.

34. The control device as claimed in claim 32, wherein the safety period (t_{saf}) is variable.

35. The control device as claimed in claim 26, wherein the safety period t_{saf} is varied as a function of at least one of a third interval t_{act} between a moment at which the target gear is fully engaged and a moment at which the clutch (14) reaches the gripping point, the result of said comparison, and a failure of the engagement of the target gear.
